(19) United States
(12) Patent Application Publication
(10) Pub. No.: US 2009/0191997 A1
(43) Pub. Date: Jul. 30, 2009

(54) ROTATING DISC

(75) Inventors: Rainer Pflug, Heilsbronn (DE); Bernd Hartmann, Weisendorf (DE); Peter Kelm, Herzogenaurach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/303,406

(22) PCT Filed: Jun. 14, 2007
(86) PCT No.: PCT/EP07/55881

§ 371 Date: Dec. 4, 2008

(30) Foreign Application Priority Data
Jun. 30, 2006 (DE) 202006010311.2

(51) Int. Cl. F16H 55/36; F16H 7/02

(52) U.S. Cl. 474/152; 474/153

(57) ABSTRACT

The form of a tooth profile for a rotating disc (10) is provided. The tooth gaps (22) formed between teeth of the rotating disc (10) are each arranged symmetrically about a tooth gap symmetry axis (30). The tooth gap symmetry axes (30) are designed such as not to pass through a circular area (14) in the region of a rotational axis (12) of the rotating disc (10).

### BACKGROUND

The present invention relates to a rotating disc, in particular, a construction of the teeth and the tooth gaps of the rotating disc. In addition, the present invention relates to a drive device with at least one rotating disc according to the invention and a looped-mechanism drive with at least one rotating disc according to the invention.

Drive systems on the basis of force-transmitting endless elements, such as, e.g., belts or chains, and gear wheels are distributed widely in industrial applications. In particular, in internal combustion engines, such drive systems are used, e.g., for transmitting a torque from the crankshaft to the camshafts.

In addition to the camshaft and the crankshaft, other components, such as, e.g., water or fuel pumps, can also be driven by belts or chains. As a generic term of belt and chain drives, one speaks of so-called looped-mechanism drives.

In such drive systems or looped-mechanism drives, so-called belt vibrations appear. Such belt vibrations can involve transversal, longitudinal, or torsional vibrations of the force-transmitting endless element, wherein these vibrations are excited by cyclical motor movements. The cyclical excitation of the belt vibration is usually realized by an asymmetric drive element of the internal combustion engine.

In particular, the torsional vibrations or rotational angle fluctuations of the individually driven components relative to each other are significant. Here, a so-called “timing error” occurs, i.e., a rotation angle of the camshaft relative to the crankshaft. If this angular error is too large, then emissions beyond the permitted pollution limits are generated during the operation of the engine.

In addition, in toothed belts, rotational angle fluctuations generate a non-uniform loading that promotes toothed belt tears and reduces the service life of the toothed belt in use.

Therefore, non-round gear wheels have been proposed, in order to equalize these belt vibrations and rotational angle fluctuations. Here, non-round gear wheels are understood to be gear wheels that do not have a circular peripheral cross section and in which the active curve or the looped arc of the force-transmitting endless element is not circular.

For example, laid-open patent application DE 10 2004 048 629 A1 describes a non-round rotating disc of a control drive. The rotating disc here has a rotating disc radius that depends functionally on the rotational angle and an average radius, wherein the average radius is selected so that a peripheral arc length of a rotating disc looped curve is equal to the product from the given distance of the midpoints of adjacent teeth and the number of teeth.

In addition, from utility model application DE 202 20 367 U1, a synchronous drive device with a plurality of rotors that are coupled with each other by a force-transmitting endless element, wherein one of the rotors has a non-circular profile with at least two projecting sections that alternate with drawn-in sections, wherein the angular positions of the projecting and drawn-in sections of the non-circular profile and the degree of eccentricity of the non-circular profile are such that the non-circular profile applies an opposite, fluctuating, correcting torque on the force-transmitting endless element, wherein this correcting torque reduces a fluctuating loading torque of a loading construction or is essentially canceled.

In the operation of the proposed rotating discs or the proposed synchronous drive devices it has been shown that the torque fluctuations can indeed be essentially equalized, but despite all of this, a high degree of belt wear occurs. The high degree of belt wear, in turn, makes short service intervals necessary and leads to high maintenance costs of the affected systems.

For torque compensation and for equalizing the rotational angle fluctuations, the previously used non-round constructions are inadequate. A disc or tooth design that prevents loading spikes and provides the most uniform “contact pattern” possible in the looped arc, i.e., the contact region between the belt and disc, is required.

### SUMMARY

The invention is based on the objective of providing a rotating disc or a drive device or a looped-mechanism drive in which rotational angle fluctuations can be equalized and in this way a significantly reduced wear of the force-transmitting endless element occurs.

This object is met by a rotating disc according to Claim 1, a drive device according to Claim 6, and a looped-mechanism drive according to Claim 10.

The rotating disc according to the invention can rotate by a rotational angle about a rotational axis and comprises a number of teeth arranged on a periphery of the rotating disc, and also tooth gaps located between the teeth, wherein the tooth gaps are each symmetrical to a tooth gap axis of symmetry, and a rotating disc radius that depends functionally on the rotational angle and a certain average radius, and is characterized in that the tooth gap axes of symmetry are each oriented essentially at the local center of curvature of the periphery of the rotating disc.

It has been shown that the cause for the high degree of wear of the force-transmitting endless elements in the rotating discs of the state of the art is due to large force spikes that are exerted by the gear teeth onto the endless element. The reason for this is the orientation and profiling of the circular gears of the state of the art.

For a circular gear, the tooth gaps located between the teeth are each symmetric to a so-called tooth gap axis of symmetry. For circular gears, each tooth gap axis of symmetry runs through the rotational axis or the center of this circular gear. The section of the gear between two such tooth gap axes of symmetry is called a sector in the scope of this description.

For a circular gear, all sectors are identical. By placing the sectors one against another, a circular gear is obtained. Here, the tooth gaps have a continuous surface without discontinuities provided with tangential transitions between the sectors.

For the non-circular gears of the state of the art, previously for the design it was also stated that all of the tooth gap axes of symmetry must run through the rotational axis of the gear. For such gears, however, identical sectors cannot be easily placed one against another. Instead, the sectors must be offset by a certain measure, in order to place the individual sectors against another along the non-circular periphery.

Now, however, on the tooth gap lines of symmetry, the tooth gaps have no transitions between the sectors like in a circular gear, but instead are more strongly curved in this region or even have a discontinuity on the tooth gap axis of symmetry. Therefore, the teeth point apart from each other at a greater angle than in a circular gear.

The tooth gap contours of the state of the art are offset so that they generate an increased load in the tooth base of the force-transmitting endless element. In addition, increased wear occurs on such contours.

According to the invention, however, the tooth gap axes of symmetry are not all oriented to the rotational axis, but instead are each directed essentially at the local center of curvature of the periphery of the rotating disc, i.e., they are perpendicular to the contours of the non-round wheel. The tooth gap axes of symmetry then usually no longer run through the rotational axis. The usually asymmetric tooth geometry is then defined by the equal tooth gaps. The flank contours of the tooth are given from the form of adjacent tooth gaps. The head contours of the tooth are given from the geometry of the contours of the active line.

Through the orientation according to the invention of the tooth gap axes of symmetry to each local center of curvature, symmetric tooth gap geometries are generated with continuous transitions between the sectors into the tooth gaps. In addition, in this way the problem of increased wear is prevented. The contact and release of the force-transmitting endless element is realized in a friction-reduced and wear-reduced way, because the pressing due to the force transmission from the teeth to the force-transmitting endless element is distributed only uniformly and force spikes are prevented. In this way, the rotating disc according to the invention provides an essential advantage relative to the state of the art.

In one embodiment it can be provided that the periphery of the rotating disc is essentially non-round. The tooth gap axes of symmetry are perpendicular to the contours of the non-round rotating disc.

In another embodiment, it can be provided that the teeth are constructed as involute gear teeth.

It can be provided that the tooth gap axes of symmetry are oriented so that a circular surface concentric to the rotating disc is not crossed by the tooth gap axes of symmetry. The circular surface can have a diameter of approximately 0.1 mm to approximately 20 mm and, in particular, a diameter of approximately 0.5 mm to approximately 6 mm.

A drive device according to the invention comprises at least two rotating discs and a force-transmitting endless element for transmitting a moment between the rotating discs and is characterized in that at least one of the rotating discs is a rotating disc according to the invention. In this way, increased wear of the force-transmitting endless element is also prevented in the drive device according to the invention.

In addition, the drive device according to the invention can be constructed for use in a motor vehicle.

Alternatively, the drive device according to the invention can be constructed for use in aircraft.

In one embodiment, the drive device according to the invention is a synchronous drive device.

The looped-mechanism drive according to the invention comprises at least two rotating discs and a force-transmitting endless element for transmitting a moment between the rotating discs and is characterized in that at least one of the rotating discs is a rotating disc according to the invention. In this way, increased wear of the force-transmitting endless element is also prevented in the looped-mechanism drive according to the invention.

Additional advantages and constructions of the invention emerge from the description and from the accompanying drawing.

It is understood that the features named above and the features still to be explained below can be used not only in each specified combination, but also in other combinations or by themselves, without departing from the scope of the present invention.

### BRIEF DESCRIPTION OF THE DRAWINGS

The invention will be explained in greater detail below with reference to an embodiment. Shown in the associated drawing are:

FIG. 1 is a cross-sectional view of a non-circular gear for compensating rotational angle fluctuations and belt vibrations of the state of the art,

FIG. 2 is an enlarged view of a region of a non-circular gear of the state of the art in FIG. 1,

FIG. 3 is a cross-sectional view of a rotating disc according to the invention in a preferred embodiment, and

FIG. 4 is an enlarged view of a region around the rotational axis of the rotating disc in FIG. 3.

### DETAILED DESCRIPTION OF THE PREFERRED EMBODIMENTS

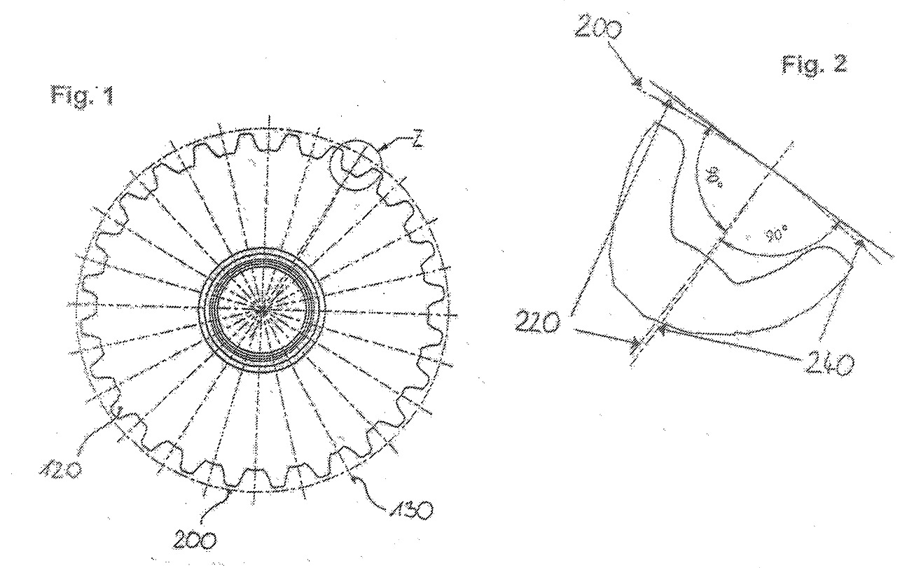

FIGS. 1 and 2 show a rotating disc 110 of the state of the art. The rotating disc 110 of the state of the art has a non-circular cross section for compensating rotational vibrations or rotational angle fluctuations. A number of teeth 120 are arranged along the periphery of the rotating disc 110. The rotating disc 110 rotates about a rotational axis 112. Tooth gaps located between the teeth 120 are each symmetric with respect to each other to a tooth gap axis of symmetry 130. The rotating disc 110 is provided along the active curve 200 in engagement with a force-transmitting endless element (not shown).

So that the individual sectors of the rotating disc 110 located between two tooth gap axes of symmetry 130 fit each other despite the non-circular cross section, they must be changed or offset. In this way, transitions with discontinuities are produced at the transitions between the teeth 120 at the tooth gap axes of symmetry 130. Through this offsetting, the problem of increased wear stated in the description introduction appears.

For comparison, in FIG. 2 a tooth gap axis of symmetry with associated tangent 220 is shown that runs through the rotational axis 112 and, in addition, maps a tooth gap axis of symmetry with associated tangent 240 that, according to the present invention, does not run through the rotational axis 112, but instead is perpendicular to the tangent and is oriented to the local center of curvature.

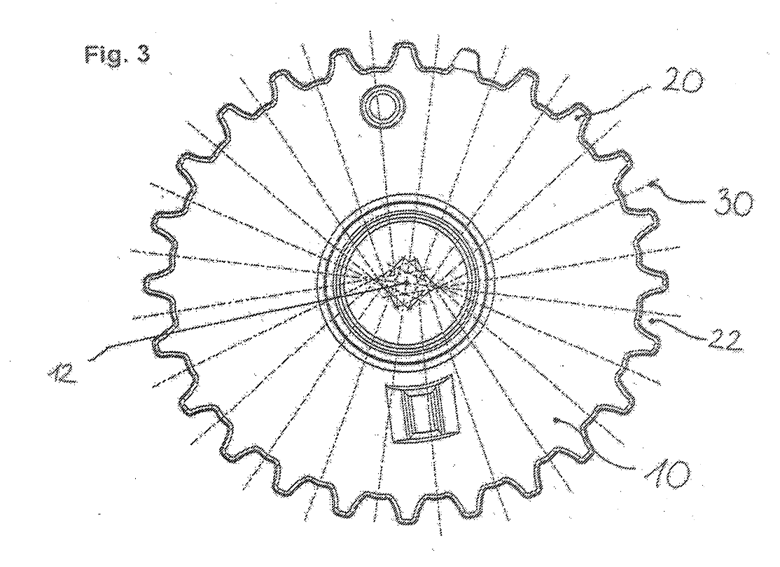

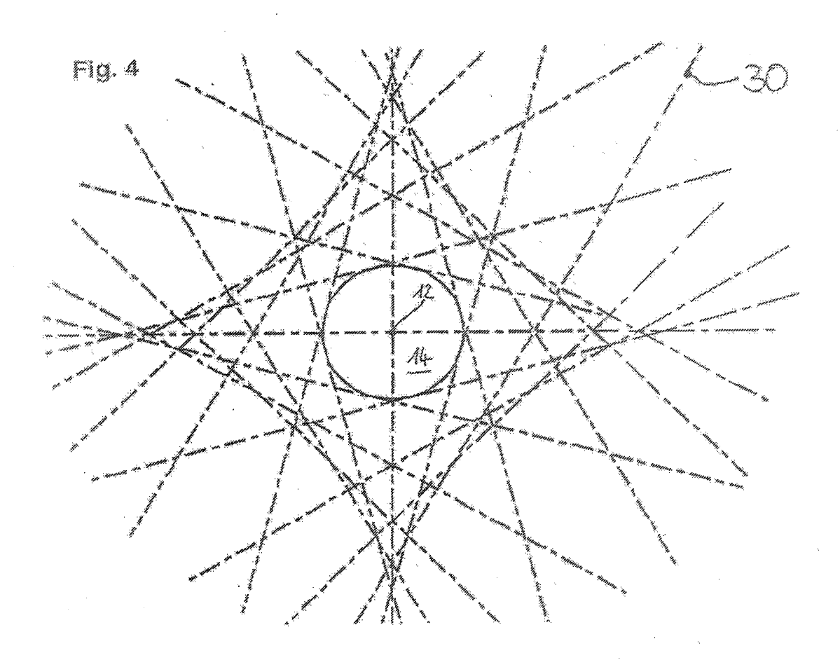

FIGS. 3 and 4 show a rotating disc 10 according to the invention that rotates about a rotational axis 12. A number of teeth 20 are arranged along the periphery of the rotating disc 10. Tooth gaps 22 located between the teeth 20 are symmetric with respect to each other along a tooth gap axis of symmetry 30. As can be seen, the tooth gap axes of symmetry 30 are not directed at the rotational axis 12 in the rotational disc 10 according to the invention. Instead, the tooth gap axes of symmetry 30 are oriented at the local centers of curvature, i.e., at the center of curvature at the point at which the tooth gap axis of symmetry 30 intersects the peripheral line of the rotating disc. Therefore, a circular surface 14 that is crossed by none of the tooth gap axes of symmetry 30 is formed around the rotational axis 12.

In this way, a symmetric construction of the tooth gaps 22 is possible along the periphery of the rotating disc 10 without offsetting and with continuous transitions of the tooth gaps at the tooth gap axes of symmetry 30. The contours of the teeth 20 are then given from the positions of the tooth gaps 22 and the contours of the active line of the rotating disc 10.

Thus, a uniform loading of a force-transmitting endless element applied to the rotating disc 10 on the teeth 20 is enabled and an engagement and release of the force-transmitting endless element is realized in a friction-reduced and wear-reduced manner. No force spikes exerted by the teeth 20 appear on the force-transmitting endless element. In this way, the wear of the force-transmitting endless element relative to the state of the art is significantly reduced, enabling longer service intervals and thus lower maintenance costs of the systems in which the rotating disc according to the invention is used.

The rotating disc according to the invention is advantageously used in a synchronous drive device or in a looped-mechanism drive. The synchronous drive device or the looped-mechanism drive is advantageously constructed for use in a motor vehicle or in aircraft. The rotating disc according to the invention, however, can also be used independent of these applications, e.g., also in textile or office machines.

### LIST OF REFERENCE SYMBOLS

10 Rotating disc
12 Rotational axis
20 Teeth
22 Tooth gaps
30 Tooth gap axes of symmetry
110 Rotating disc (state of the art)
112 Rotational axis (state of the art)
120 Teeth (state of the art)
130 Tooth gap axes of symmetry (state of the art)
200 Active curve (state of the art)
220 Tooth gap axis of symmetry through rotational axis with associated tangent (state of the art)
240 Tooth gap axis of symmetry outside of rotational axis with associated tangent

1. Rotating disc that can rotate by a rotational angle about a rotational axis comprising a plurality of teeth arranged on a periphery of the rotating disc and tooth gaps located between the teeth, the tooth gaps are each symmetric to a tooth gap axis of symmetry, and a rotating disc radius that depends functionally on the rotational angle and a certain average radius, the tooth gap axes of symmetry are each oriented essentially at a local center of curvature of the periphery of the rotating disc.

2. Rotating disc according to claim 1, wherein the periphery of the rotating disc is generally non-circular.

3. Rotating disc according to claim 1, wherein the teeth are constructed as involute gear teeth.

4. Rotating disc according to claim 1, further comprising a circular surface on the disc that is concentric to the rotating disc and that is not crossed by the tooth gap axes of symmetry, and the circular surface has a diameter of approximately 0.1 mm to approximately 20 mm.

5. Rotating disc according to claim 4, wherein the circular surface has a diameter of approximately 0.5 mm to approximately 6 mm.

6. Drive device with at least two rotating discs and a force-transmitting endless element for transmitting a force between the rotating discs, at least one of the rotating discs is a rotating disc comprising a plurality of teeth arranged on a periphery of the rotating disc and tooth gaps located between the teeth, the tooth gaps are each symmetric to a tooth gap axis of symmetry, and a rotating disc radius that depends functionally on the rotational angle and a certain average radius, the tooth gap axes of symmetry are each oriented essentially at a local center of curvature of the periphery of the rotating disc.

7. Drive device according to claim 6, wherein the drive device is in a motor vehicle.

8. Drive device according to claim 6, wherein the drive device is in an aircraft.

9. Drive device according to claim 6, wherein the drive device is a synchronous drive device.

10. Looped-mechanism drive with at least two rotating discs and a force-transmitting endless element for transmitting a force between the rotating discs, at least one of the rotating discs is a rotating disc comprising a plurality of teeth arranged on a periphery of the rotating disc and tooth gaps located between the teeth, the tooth gaps are each symmetric to a tooth gap axis of symmetry, and a rotating disc radius that depends functionally on the rotational angle and a certain average radius, the tooth gap axes of symmetry are each oriented essentially at a local center of curvature of the periphery of the rotating disc.
